(19) United States
(12) Patent Application Publication
(10) Pub. No.: US 2012/0028637 A1
(43) Pub. Date: Feb. 2, 2012

(54) APPARATUS AND METHODS FOR NETWORK SCANNING FOR MANUAL PLMN SEARCH

(75) Inventors: Anand Kashikar, Sunnyvale, CA (US); Nitin Kumar, San Ramon, CA (US)

(73) Assignee: PALM, INC., Sunnyvale, CA (US)

(21) Appl. No.: 12/845,646

(22) Filed: Jul. 28, 2010

(51) Int. Cl. H04W 8/00

(52) U.S. Cl. 455/426.1

(57) ABSTRACT

Various embodiments for providing enhanced manual PLMN search in mobile devices are described. In one or more embodiments, a user may initiate a manual PLMN search while the mobile device has a data connection to a network. The mobile network carrier may receive a request from the mobile device to suspend the data connection between the device and the mobile network carrier while the device performs the manual public land mobile network (PLMN) search. The mobile network may suspend the data connection. The suspended data connection may be resumed, without being torn down and re-established, if the user re-selects the mobile network after the manual PLMN search. Other embodiments are described and claimed.

### BACKGROUND

A mobile computing device such as a combination handheld computer and mobile telephone or smart phone generally may provide voice and data communications functionality, as well as computing and processing capabilities. Mobile computing devices may need to change to a different network. Searching for a new network and then either resuming or changing networks after a search may be time consuming and inefficient. Accordingly, there may be a need for an improved apparatus and methods for improving performance during a network search.

### BRIEF DESCRIPTION OF THE DRAWINGS

FIG. 1 illustrates a mobile computing device in accordance with one or more embodiments.

FIG. 2 illustrates a system in accordance with one or more embodiments.

FIG. 3 illustrates a network in accordance with one or more embodiments.

FIG. 4 illustrates a logic flow in accordance with one or more embodiments.

### DETAILED DESCRIPTION

Various embodiments are directed to providing improved performance during and after manual public land mobile network (PLMN) searches on mobile computing devices. In one or more embodiments, a mobile computing device may be able to suspend an active data connection to a network to make a manual PLMN search possible. After the search, if the same network is selected, then embodiments may resume the connection. Conventionally, an active data or voice connection must be torn down in order to accommodate a manual PLMN search, and then re-established as a new connection regardless of whether the same network is later selected. Both tearing down and re-establishing connections take time, in some cases on the order of tens of seconds. Embodiments may apply to the universal mobile telecommunication system (UMTS), e.g. to 3G networks. Embodiments may provide a new signaling procedure to the 3^{rd} Generation Partnership Project (3GPP) standards, e.g. to 3GPP 24.0008.

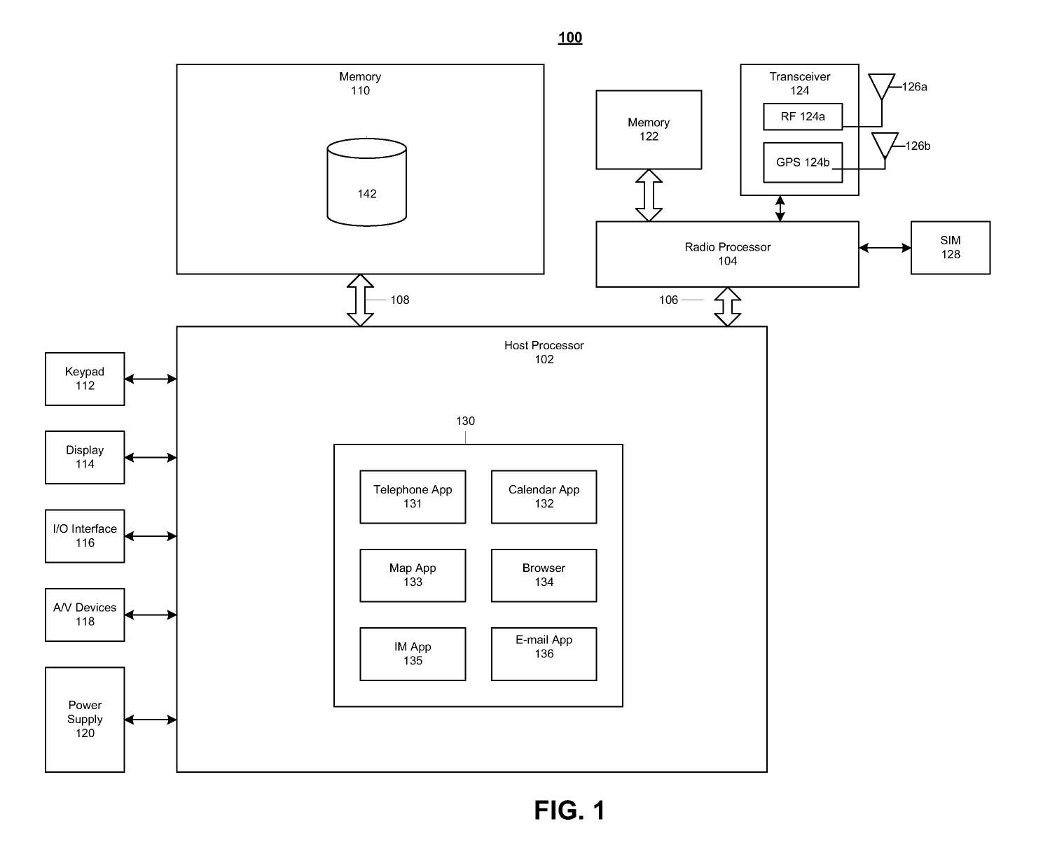

FIG. 1 illustrates a mobile computing device 100 in accordance with one or more embodiments. The mobile computing device 100 may be implemented as a combination handheld computer and mobile telephone, sometimes referred to as a smart phone. Examples of smart phones include, but are not limited to, for example, Palm® products such as Palm® Treo™ and Palm® Pre™ smart phones. Although some embodiments may be described with the mobile computing device 100 implemented as a smart phone by way of example, it may be appreciated that the embodiments are not limited in this context. For example, the mobile computing device 100 may comprise, or be implemented as, any type of wireless device, mobile station, or portable computing device with a self-contained power source (e.g., battery) such as a laptop computer, ultra-laptop computer, personal digital assistant (PDA), cellular telephone, combination cellular telephone/PDA, mobile unit, subscriber station, user terminal, portable computer, handheld computer, palmtop computer, wearable computer, media player, pager, messaging device, data communication device, and so forth.

The mobile computing device 100 may provide voice communications functionality in accordance with different types of cellular radiotelephone systems. Examples of cellular radiotelephone systems may include Code Division Multiple Access (CDMA) systems, Global System for Mobile Communications (GSM) systems, North American Digital Cellular (NADC) systems, Time Division Multiple Access (TDMA) systems, Extended-TDMA (E-TDMA) systems, Narrowband Advanced Mobile Phone Service (NAMPS) systems, third generation (3G) systems such as Wide-band CDMA (WCDMA), CDMA-2000, Universal Mobile Telephone System (UMTS) systems, and so forth.

In addition to voice communications functionality, the mobile computing device 100 may be arranged to provide data communications functionality in accordance with different types of cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and so forth.

The mobile computing device 100 may be arranged to provide voice and/or data communications functionality in accordance with different types of wireless network systems. Examples of wireless network systems may include a wireless local area network (WLAN) system, wireless metropolitan area network (WMAN) system, wireless wide area network (WWAN) system, and so forth. Examples of suitable wireless network systems offering data communication services may include the Institute of Electrical and Electronics Engineers (IEEE) 802.xx series of protocols, such as the IEEE 802.11a/b/g/n series of standard protocols and variants (also referred to as “WiFi”), the IEEE 802.16 series of standard protocols and variants (also referred to as “WiMAX”), the IEEE 802.20 series of standard protocols and variants, and so forth.

The mobile computing device 100 may be arranged to perform data communications in accordance with different types of shorter range wireless systems, such as a wireless personal area network (PAN) system. One example of a suitable wireless PAN system offering data communication services may include a Bluetooth system operating in accordance with the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Other examples may include systems using infrared techniques or near-field communication techniques and protocols, such as electro-magnetic induction (EMI) techniques. An example of EMI techniques may include passive or active radio-frequency identification (RFID) protocols and devices.

As shown in the embodiment of FIG. 1, the mobile computing device 100 may comprise a dual processor architecture including a host processor 102 and a radio processor 104. In various implementations, the host processor 102 and the radio processor 104 may be arranged to communicate with each other using interfaces 106, such as one or more universal serial bus (USB) interfaces, micro-USB interfaces, universal asynchronous receiver-transmitter (UART) interfaces, general purpose input/output (GPIO) interfaces, control/status lines, control/data lines, audio lines, and so forth.

The host processor 102 may be responsible for executing various software programs such as system programs and applications programs to provide computing and processing operations for the mobile computing device 100. The radio processor 104 may be responsible for performing various voice and data communications operations for the mobile computing device 100 such as transmitting and receiving voice and data information over one or more wireless communications channels. Although some embodiments may be described as comprising a dual processor architecture for purposes of illustration, the mobile computing device 100 may comprise any suitable processor architecture and/or any suitable number of processors consistent with the described embodiments.

The host processor 102 may be implemented as a host central processing unit (CPU) using any suitable processor or logic device, such as a general purpose processor. Although some embodiments may be described with the host processor 102 implemented as a CPU or general purpose processor by way of example, it may be appreciated that the embodiments are not limited in this context. For example, the host processor 102 may comprise, or be implemented as, a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the host processor 102 may be coupled through a memory bus 108 to a memory 110. The memory bus 108 may comprise any suitable interface and/or bus architecture for allowing the host processor 102 to access the memory 110. Although the memory 110 may be shown as being separate from the host processor 102 for purposes of illustration, in various embodiments some portion or the entire memory 110 may be included on the same integrated circuit as the host processor 102. Alternatively, some portion or the entire memory 110 may be disposed on an integrated circuit or other medium (e.g., hard disk drive) external to the integrated circuit of host processor 102. In various embodiments, the mobile computing device 100 may comprise an expansion slot to support a multimedia and/or memory card, for example.

The memory 110 may be implemented using any machine-readable or computer-readable media capable of storing data such as volatile memory or non-volatile memory, removable or non-removable memory, erasable or non-erasable memory, writeable or re-writeable memory, and so forth. Examples of machine-readable storage media may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The mobile computing device 100 may comprise an alphanumeric keypad 112 coupled to the host processor 102. The keypad 112 may comprise, for example, a QWERTY key layout and an integrated number dial pad. The mobile computing device 100 also may comprise various keys, buttons, and switches such as, for example, input keys, preset and programmable hot keys, left and right action buttons, a navigation button such as a multidirectional navigation button, phone/send and power/end buttons, preset and programmable shortcut buttons, a volume rocker switch, a ringer on/off switch having a vibrate mode, and so forth.

The mobile computing device 100 may comprise a display 114 coupled to the host processor 102. The display 114 may comprise any suitable visual interface for displaying content to a user of the mobile computing device 100. In one embodiment, for example, the display 114 may be implemented by a liquid crystal display (LCD) such as a touch-sensitive color (e.g., 16-bit color) thin-film transistor (TFT) LCD screen. In some embodiments, the touch-sensitive LCD may be used with a stylus and/or a handwriting recognizer program.

The mobile computing device 100 may comprise an input/output (I/O) interface 116 coupled to the host processor 102. The I/O interface 116 may comprise one or more I/O devices such as a serial connection port, an infrared port, integrated Bluetooth® wireless capability, and/or integrated 802.11x (WiFi) wireless capability, to enable wired (e.g., USB cable) and/or wireless connection to a local computer system, such as a local personal computer (PC). In various implementations, mobile computing device 100 may be arranged to transfer and/or synchronize information with the local computer system.

The host processor 102 may be coupled to various audio/video (A/V) devices 118 that support A/V capability of the mobile computing device 100. Examples of A/V devices 118 may include, for example, a microphone, one or more speakers, an audio port to connect an audio headset, an audio coder/decoder (codec), an audio player, a digital camera, a video camera, a video codec, a video player, and so forth.

The host processor 102 may be coupled to a power supply 120 arranged to supply and manage power to the elements of the mobile computing device 100. In various embodiments, the power supply 120 may be implemented by a rechargeable battery, such as a removable and rechargeable lithium ion battery to provide direct current (DC) power, and/or an alternating current (AC) adapter to draw power from a standard AC main power supply. In various embodiments, power supply 120 may be rechargeable via a USB connection, a wall outlet, solar power, etc.

As mentioned above, the radio processor 104 may perform voice and/or data communication operations for the mobile computing device 100. For example, the radio processor 104 may be arranged to communicate voice information and/or data information over one or more assigned frequency bands of a wireless communication channel. In various embodiments, the radio processor 104 may be implemented as a communications processor using any suitable processor or logic device, such as a modem processor or baseband processor. Although some embodiments may be described with the radio processor 104 implemented as a modem processor or baseband processor by way of example, it may be appreciated that the embodiments are not limited in this context. For example, the radio processor 104 may comprise, or be implemented as, a digital signal processor (DSP), media access control (MAC) processor, or any other type of communications processor in accordance with the described embodiments.

In various embodiments, the radio processor 104 may perform analog and/or digital baseband operations for the mobile computing device 100. For example, the radio processor 104 may perform digital-to-analog conversion (DAC), analog-to-digital conversion (ADC), modulation, demodulation, encoding, decoding, encryption, decryption, and so forth.

The mobile computing device 100 may comprise a memory 122 coupled to the radio processor 104. The memory 122 may be implemented using one or more types of machine-readable or computer-readable media capable of storing data such as volatile memory or non-volatile memory, removable or non-removable memory, erasable or non-erasable memory, writeable or re-writeable memory, and so forth. The memory 122 may comprise, for example, flash memory and secure digital (SD) RAM. Although the memory 122 may be shown as being separate from and external to the radio processor 104 for purposes of illustration, in various embodiments some portion or the entire memory 122 may be included on the same integrated circuit as the radio processor 104.

The mobile computing device 100 may comprise a transceiver module 124 coupled to the radio processor 104. The transceiver module 124 may comprise one or more transceivers arranged to communicate using different types of protocols, communication ranges, operating power requirements, RF sub-bands, information types (e.g., voice or data), use scenarios, applications, and so forth. The transceiver module 124 generally may be implemented using one or more chips as desired for a given implementation. Although the transceiver module 124 may be shown as being separate from and external to the radio processor 104 for purposes of illustration, in various embodiments some portion or the entire transceiver module 124 may be included on the same integrated circuit as the radio processor 104.

In various embodiments, the transceiver module 124 may comprise one or more transceivers or components arranged to support voice and/or data communications for the wireless network systems or protocols as previously described. For example, the mobile computing device 100 may comprise one or more radio frequency (RF) transceivers 124a supporting voice communication (e.g., CDMA, GSM, UMTS), WWAN data communication (e.g., EVDO, EVDV, CDMA/1xRTT, GSM/GPRS, EDGE, HSDPA), WLAN data communication (e.g., WiFi, WiMAX), and/or WPAN data communication (e.g., Infrared protocols, Bluetooth®, IR, EMI) in accordance with the described embodiments. The transceiver module 124 may further comprise a GPS transceiver 124b supporting position determination in accordance with the described embodiments.

The mobile computing device 100 may comprise an antenna system 126 coupled to the radio processor 104 through the transceiver module 124. The antenna system 126 may transmit and/or receive electrical signals and may comprise or be implemented as one or more internal antennas and/or external antennas tuned for operating at one or more frequency bands. As shown, the antenna system 126 may comprise one or more antennas 126a connected to one or more RF transceivers 124a supporting voice and/or data communications in accordance with the described embodiments. The antenna system 126 may further comprise a GPS antenna 126b connected to the GPS transceiver 124b supporting position determination in accordance with the described embodiments.

The mobile computing device 100 may comprise a subscriber identity module (SIM) 128 coupled to the radio processor 104. The SIM 128 may comprise, for example, a removable or non-removable smart card arranged to encrypt voice and data transmissions and to store user-specific data for allowing a voice or data communications network to identify and authenticate the user. The SIM 128 also may store data such as personal settings specific to the user.

As mentioned above, the host processor 102 may be arranged to provide processing or computing resources to the mobile computing device 100. For example, the host processor 102 may be responsible for executing various software programs such as system programs and application programs to provide computing and processing operations for the mobile computing device 100.

System programs (not shown) generally may assist in the running of the mobile computing device 100 and may be directly responsible for controlling, integrating, and managing the individual hardware components of the computer system. Examples of system programs may include, without limitation, an operating system (OS), device drivers, programming tools, utility programs, software libraries, application programming interfaces (APIs), and so forth. The mobile computing device 100 may use any suitable OS in accordance with the described embodiments, such as a Palm OS®, Palm OS® Cobalt, Palm® webOS™, Microsoft® Windows OS, Microsoft Windows® CE, Microsoft Pocket PC, Microsoft Mobile, Symbian OS™, Embedix OS, Linux, Binary Run-time Environment for Wireless (BREW) OS, JavaOS, a Wireless Application Protocol (WAP) OS, and so forth.

Application programs generally may allow a user to accomplish one or more specific tasks. Examples of application programs may include, without limitation, one or more messaging applications (e.g., telephone, voicemail, facsimile, e-mail, IM, SMS, MMS, video conferencing), a web browser application, personal information management (PIM) applications (e.g., contacts, calendar, scheduling, tasks), word processing applications, spreadsheet applications, database applications, media applications (e.g., video player, audio player, multimedia player, digital camera, video camera, media management), gaming applications, and so forth. In various implementations, the application programs may provide one or more graphical user interfaces (GUIs) to communicate information between the mobile computing device 100 and a user. In some embodiments, application programs may comprise upper layer programs running on top of the OS of the host processor 102 that operate in conjunction with the functions and protocols of lower layers including, for example, a transport layer such as a Transmission Control Protocol (TCP) layer, a network layer such as an Internet Protocol (IP) layer, and a link layer such as a Point-to-Point (PPP) layer used to translate and format data for communication.

As shown in FIG. 1, the mobile computing device 100 may comprise or implement several applications 130 arranged to provide a variety of functionality to device 100. The applications 130 may comprise, for example, a telephone application 131 such as a cellular telephone application, a Voice over Internet Protocol (VoIP) application, a Push-to-Talk (PTT) application, and so forth. The applications 130 may further comprise a calendar application 132, a map application 133, an Internet browser application 134, an instant messaging (IM) application 135, an e-mail application 136, etc.

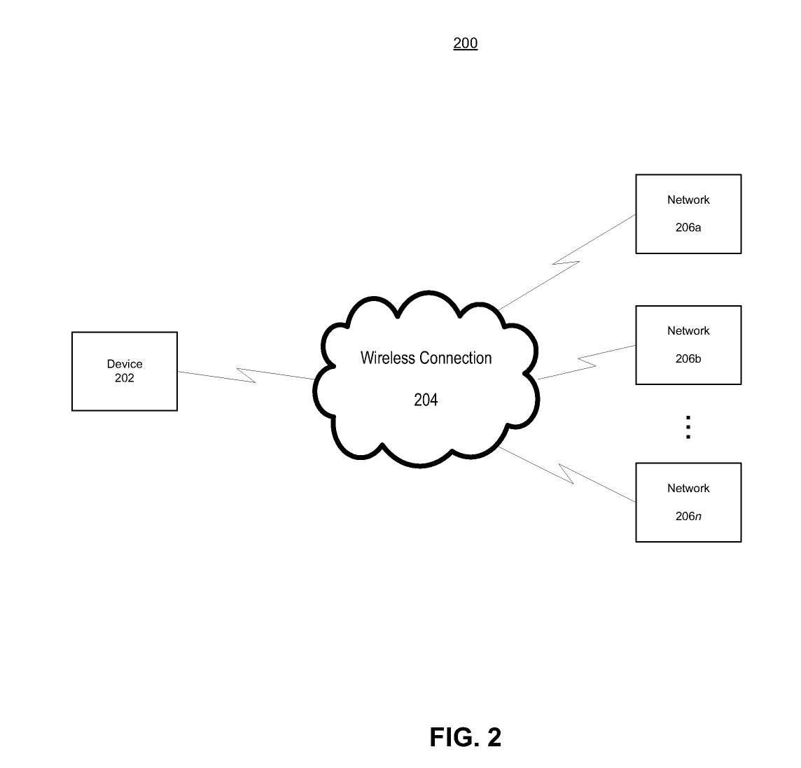

FIG. 2 is a block diagram 200 illustrating an embodiment of a system. A mobile device 202 may be in communication with a network, e.g. network 206a, network 206b, or 206n, via wireless connection 204. A network 206 may include a mobile communications network such as, for example, AT&T®, T-Mobile®, Verizon®, etc.

In an embodiment, mobile device 202 may have an active data connection to network 206a. When mobile device 202 is in a roaming mode, network 206a may no longer be available for the data connection. Another available network, say network 206b, may not have a roaming agreement with network 206a. While 206b may pick up the data connection, in fact, no packets may be transmitted. In such a case, the user of mobile device 202 may wish to initiate a manual public land mobile network (PLMN) search to locate a network that does have a roaming agreement with the user's primary network.

Conventionally, in such a situation, UMTS cannot scan for other networks while mobile device 202 is in a CELL_DCH or CELL_FACH state. In that case, the connection may time out, and mobile device 202 may disconnect from network 206b. Mobile device 202 would then have to establish a new connection to a network.

Embodiments of the invention allow mobile device 202 to suspend a data connection, rather than tearing down the data connection, to allow a manual PLMN search. In an embodiment, the device notifies the network 206 in use to suspend the sending of data packets.

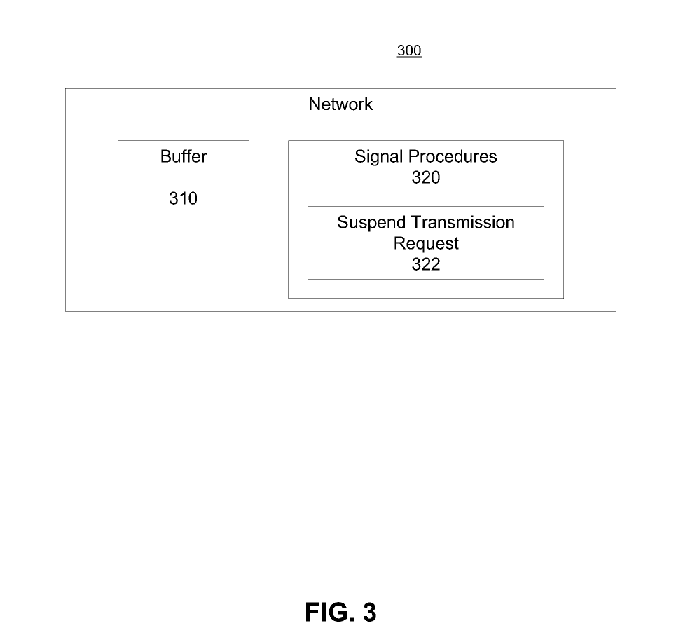

FIG. 3 illustrates a block diagram of a network 300 in accordance with one or more embodiments. Network 300 may be an embodiment of a network 206. Network 300 may be configured to allow transmission of data packets to be suspended while a device connected to network 300 performs a manual PLMN search. In an embodiment, network 300 may include a buffer 310. Buffer 310 may store data packets for transmission to a device that has requested a suspension in transmission. If the device user selects the same network 206 after the manual PLMN search, then the data in buffer 310 may be transmitted to the device when the connection is resumed. In other embodiments, a network 300 may not buffer data packets, and may instead suspend transmission without preserving data.

Network 300 may also include one or more signal procedures 320. Signal procedures 320 may include signal procedures that are part of a standard, such as the 3GPP standards. Signal procedures 320 may include a suspend transmission request 322 that, when received from a device, will cause network 300 to suspend data transmissions to the device. In an embodiment, suspend transmission request 322 may be in the form of a standards-based request, procedure or method. The suspend transmission request may be part of 3GPP 24.008, for example. In an embodiment, the suspend transmission request may have a form analogous to that found in 3GPP 44.018 specifications Section 9.1.13b.

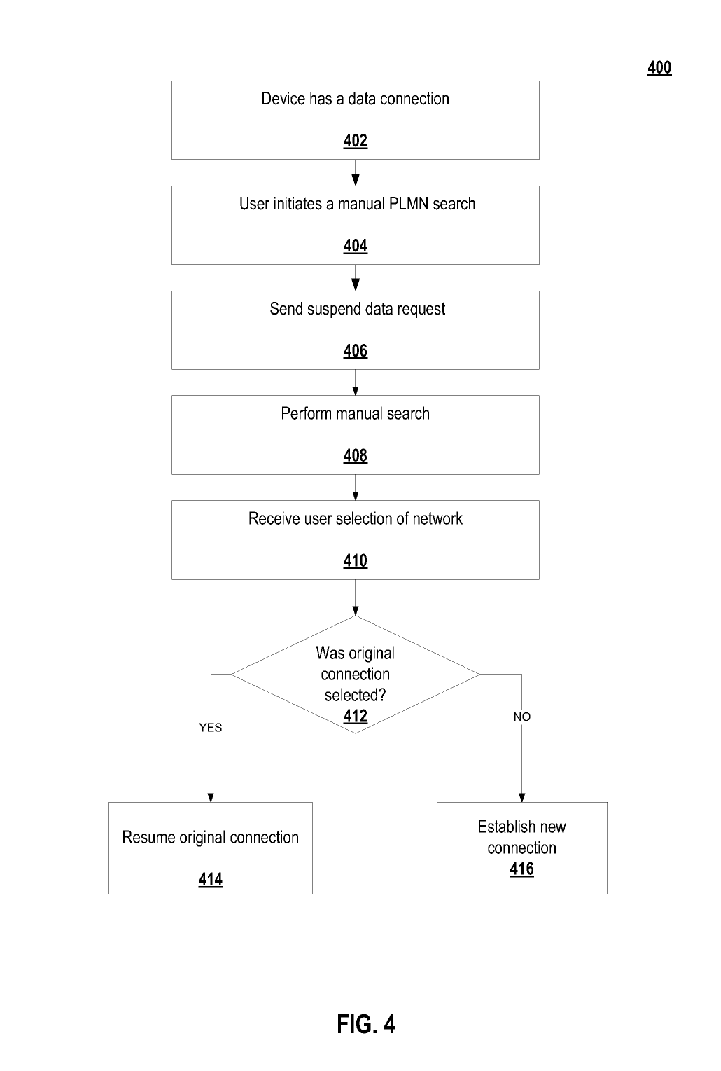

FIG. 4 illustrates a logic flow 400 in accordance with one or more embodiments. The logic flow 400 may be performed by various systems and/or devices and may be implemented as hardware, software, and/or any combination thereof, as desired for a given set of design parameters or performance constraints. For example, the logic flow 400 may be implemented by a logic device (e.g., processor) and/or logic (e.g., power management module) comprising instructions, data, and/or code to be executed by a logic device. For purposes of illustration, and not limitation, the logic flow 400 is described with reference to FIG. 1. The embodiments are not limited in this context.

As shown in logic flow 400, in block 402, a mobile device has a data connection to a first network. During the data connection, circumstances may occur that prompt the user of the device to want to search for another network. For example, the user and device may be in a location where the device is in roaming mode, and the data connection may be with a different carrier that does not have a data connection roaming agreement available for the device. In such a case, the device may appear to have a data connection but no packets may be transferred. In another example, the connection may be of poor quality.

In block 404, the user may initiate a manual PLMN search.

In block 406, the device may send a suspend data request to the first network. The first network may receive the suspend data request and cease sending any packets to the device but without tearing down the connection. The first network may buffer the packets or may discard the packets.

In block 408, the device may perform the manual PLMN search and locate any available networks, which may include the first network. The device may display the available networks located during the PLMN search to the user via the display. In an embodiment, the device may provide information about the available networks, such as but not limited to, signal strength, cost of using the network, etc.

In block 410, the device may receive the user's selection of an available network. If the user re-selects the first network in block 412, then in block 414, the original data connection with the first network is resumed. The device may, for example, send a resume data request to the first network. If any data packets were buffered by the first network, the data packets may then be transmitted to the device.

If the user selects a second network in block 412, then in block 416, the first connection may be deregistered, and a new data connection with the second network may constructed and established.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

Any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A system to send and receive wireless communications, comprising:
a mobile network carrier to receive a request from a mobile device to suspend a data connection between the device and the mobile network carrier while the device performs a manual public land mobile network (PLMN) search; and to suspend the data connection.

2. The system of claim 1, the mobile network carrier to resume the data connection if the device selects the mobile network carrier after the PLMN search.

3. The system of claim 1, the mobile network carrier comprising:
a wireless receiver to receive the request to suspend;
a buffer to store data, while the data connection is suspended, from the data connection to be sent to the device.

4. The system of claim 1, wherein the request to suspend is a 3GPP signaling procedure.

5. The system of claim 1, the device to tear down the data connection if the device selects a different mobile network carrier after the PLMN search.

6. The system of claim 1, the mobile network carrier to drop packets while the data connection is suspended.

7. A method operating on a wireless computing device, the method comprising:
receiving a user request to initiate a manual public land mobile network (PLMN) search while the device has a data connection on a first network;
sending a suspend data request to the first network to suspend the data connection;
performing the manual PLMN search; and
receiving a user selection of a network from the search.

8. The method of claim 7, further comprising:
when the user selected network is the first network, sending a resume data request to the first network; and
resuming the data connection with the first network.

9. The method of claim 7, further comprising:
receiving the suspend data request from the device at the first network; and
suspending data packet transmission from the first network to the device.

10. The method of claim 9, wherein suspending comprises:
buffering data packets to be transmitted to the device.

11. The method of claim 9, wherein suspending comprises:
dropping data packets to be transmitted to the device.

12. The method of claim 7, further comprising, when the user selected network is a second network:
tearing down the data connection to the first network; and
establishing a second data connection to the second network.

13. The method of claim 7, wherein the suspend data request is a 3GPP signaling procedure.

14. A machine-readable storage medium comprising instructions that when executed enable a wireless computing device to:
receive a user request to initiate a manual public land mobile network (PLMN) search while the device has a data connection on a first network;
send a suspend data request to the first network to suspend the data connection;
perform the manual PLMN search;
display the results of the manual PLMN search; and
receive a user selection of a network from the results of the search.

15. The machine-readable medium of claim 14, further comprising instructions that when executed enable the wireless computing device to:
send a resume data request to the first network when the user selected network is the first network; and
resume the data connection with the first network.

16. The machine-readable medium of claim 14, further comprising instructions that when executed enable the first network to:
receive the suspend data request from the device at the first network; and
suspend data packet transmission from the first network to the device.

17. The machine-readable medium of claim 16, further comprising instructions that when executed enable the first network to:
buffer data packets to be transmitted to the device.

18. The machine-readable medium of claim 16, further comprising instructions that when executed enable the first network to:
drop data packets to be transmitted to the device.

19. The machine-readable medium of claim 14, further comprising instructions that when executed enable the mobile device to, when the user selected network is a second network:
tear down the data connection to the first network; and
establish a second data connection to the second network.

20. The machine-readable medium of claim 14, wherein the suspend data request is a 3GPP signaling procedure.
